(19) United States
(12) Patent Application Publication
(10) Pub. No.: US 2025/0065911 A1
(43) Pub. Date: Feb. 27, 2025

(54) Method for the at least Partially Automated Guidance of a Motor Vehicle

(71) Applicant: Robert Bosch GmbH, Stuttgart-Feuerbach (DE)

(72) Inventors: Stefan Nordbruch, Leonberg (DE); Nico Latsch, Oppenweiler (DE); Felix Hess, Benningen (DE); Michael Gabb, Gaufelden (DE); Carsten Hammerling, Gartringen (DE); Sascha Muhlbrandt, Wiernsheim (DE); Sebastian Hahn, Sindelfingen (DE)

(73) Assignee: Robert Bosch GmbH, Stuttgart-Feuerbach (DE)

(21) Appl. No.: 18/812,452

(22) Filed: Aug. 22, 2024

(30) Foreign Application Priority Data
Aug. 22, 2023 (DE) 10 2023 122 448.4

(51) Int. Cl. B60W 60/00

(52) U.S. Cl. CPC B60W 60/001; B60W 2556/10; B60W 2556/40

(57) ABSTRACT

An at least partially automated guidance of a motor vehicle includes receiving infrastructure-generated environment data describing an environment of the motor vehicle, and deciding, based on the infrastructure-generated environment data, which of three driving strategies to use for the at least partially automated guidance of the motor vehicle. The first driving strategy stipulates that only motor vehicle-generated environment data is used. The second driving strategy stipulates that both the motor vehicle-generated environment data and the infrastructure-generated environment data are used. The third driving strategy stipulates that only the infrastructure-generated environment data is used. On the basis of the decision, control signals for the at least partially automated control of the lateral and/or longitudinal guidance of the motor vehicle are generated and output.

### CROSS-REFERENCE TO RELATED APPLICATION

This application claims the benefit of the filing date under 35 U.S.C. § 119(a)-(d) of German Patent Application No. 10 2023 122 448.4, filed on Aug. 22, 2023.

### FIELD OF THE INVENTION

The invention relates to a method for the at least partially automated guidance of a motor vehicle, a device, a motor vehicle, a computer program and a machine-readable storage medium.

### BACKGROUND

The published patent application DE 10 2012 222 562 A1 discloses a system for managed parking spaces for transferring a vehicle from a starting position to a target position.

### SUMMARY

An at least partially automated guidance of a motor vehicle includes receiving infrastructure-generated environment data describing an environment of the motor vehicle, and deciding, based on the infrastructure-generated environment data, which of three driving strategies to use for the at least partially automated guidance of the motor vehicle. The first driving strategy stipulates that only motor vehicle-generated environment data is used. The second driving strategy stipulates that both the motor vehicle-generated environment data and the infrastructure-generated environment data are used. The third driving strategy stipulates that only the infrastructure-generated environment data is used. On the basis of the decision, control signals for the at least partially automated control of the lateral and/or longitudinal guidance of the motor vehicle are generated and output.

### BRIEF DESCRIPTION OF THE DRAWINGS

The invention is explained in greater detail below on the basis of exemplary embodiments, in which:

FIG. 1 shows a flowchart of a method according to a first aspect;

FIG. 2 shows a block diagram of a device according to a second aspect;

FIG. 3 shows a schematic diagram of a motor vehicle according to a third aspect;

FIG. 4 shows a block diagram of a machine-readable storage medium according to a fifth aspect;

FIG. 5 shows a schematic diagram of a parking area;

FIG. 6 shows a block diagram of a process flow of an AVP process;

FIG. 7 shows a block diagram of a first portion of the process flow of FIG. 6;

FIG. 8 shows a block diagram of a second portion of the process flow of FIG. 6;

FIG. 9 is a block diagram of a process flow of a vehicle driving according to a first driving strategy;

FIG. 10 is a block diagram of a process flow of an initialization process;

FIG. 11 is a block diagram of a procedure of driving in at least highly automated manner from the standpoint of the motor vehicle;

FIG. 12 is a block diagram of a procedure of driving in at least highly automated manner from the standpoint of the infrastructure; and

FIG. 13 is a block diagram showing the procedure of FIG. 11 in greater detail.

### DETAILED DESCRIPTION OF THE EMBODIMENTS

The same reference signs may be used for the same features below. The embodiments and exemplary embodiments described here may be combined with one another in any desired way, even if this is not explicitly described.

A first aspect provides a method for the at least partially automated guidance of a motor vehicle, comprising the following steps:
receiving infrastructure-generated environment data describing an environment of the motor vehicle,
deciding which of three driving strategies ought to be used for the at least partially automated guidance of the motor vehicle, on the basis of the infrastructure-generated environment data,
wherein a first of the three driving strategies stipulates that only motor vehicle-generated environment data, and not the infrastructure-generated environment data, ought to be used for a representation of the environment of the motor vehicle on the basis of which the motor vehicle ought to be guided in an at least partially automated manner,
wherein a second of the three driving strategies stipulates that motor vehicle-generated environment data and the infrastructure-generated environment data ought to be used for a representation of the environment of the motor vehicle on the basis of which the motor vehicle ought to be guided in an at least partially automated manner,
wherein a third of the three driving strategies stipulates that only the infrastructure-generated environment data, and not motor vehicle-generated environment data, ought to be used for a representation of the environment of the motor vehicle on the basis of which the motor vehicle ought to be guided in an at least partially automated manner,
generating control signals for the at least partially automated control of the longitudinal and/or lateral guidance of the motor vehicle on the basis of the decision,
outputting the generated control signals.

A second aspect provides a device configured to perform all the steps of the method according to the first aspect.

A third aspect provides a motor vehicle comprising the device according to the second aspect.

A fourth aspect provides a computer program comprising instructions which, when the computer program is executed by a computer, for example by the device according to the second aspect, cause the latter to perform a method according to the first aspect.

A fifth aspect provides a machine-readable storage medium on which the computer program according to the fourth aspect is stored.

The invention is based on and includes the insight that the above object is achieved by virtue of environment data describing an environment of the motor vehicle being received by the motor vehicle. These environment data were generated by infrastructure, i.e. externally to the motor vehicle. This means that the infrastructure generated these environment data and transmits them to the motor vehicle.

On the basis of the infrastructure-generated environment data, the motor vehicle decides which of three driving strategies ought to be used for the at least partially automated guidance of the motor vehicle.

In this case, the first of the three driving strategies stipulates that only motor vehicle-generated environment data, i.e. not the infrastructure-generated environment data, ought to be used for a representation of the environment of the motor vehicle on the basis of which the motor vehicle ought to be guided in an at least partially automated manner.

The second of the three driving strategies stipulates that both motor vehicle-generated environment data and the infrastructure-generated environment data ought to be used for the representation of the environment of the motor vehicle.

The third of the three driving strategies stipulates that only the infrastructure-generated environment data, i.e. not motor vehicle-generated environment data, ought to be used for the representation of the environment of the motor vehicle.

This means that, in the context of the first driving strategy, the environment of the motor vehicle is represented only by motor vehicle-generated environment data or only on the basis of motor vehicle-generated environment data, and not by the infrastructure-generated environment data. This means that, in the context of the second driving strategy, the environment of the motor vehicle is represented both by the motor vehicle-generated environment data and by the infrastructure-generated environment data or both on the basis of motor vehicle-generated environment data and on the basis of infrastructure-generated environment data. This means that, in the context of the third driving strategy, the environment of the motor vehicle is represented only by the infrastructure-generated environment data or only on the basis of the infrastructure-generated environment data, and not by the motor vehicle-generated environment data.

On the basis of the decision, i.e. on the basis of which of the three driving strategies ought to be used for the at least partially automated guidance of the motor vehicle, control signals for the at least partially automated control of the longitudinal and/or lateral guidance of the motor vehicle are generated. This means in particular that the control signals are generated on the basis of that representation of the environment which corresponds to that driving strategy in favor of which the motor vehicle decided. The generated control signals are output in order to guide the motor vehicle in an at least partially automated manner.

As a result, therefore, the technical advantage is afforded that, depending on the decision, the infrastructure supports the motor vehicle in the at least partially automated driving or in the at least partially automated guidance. As a result, the motor vehicle may advantageously drive safely through the infrastructure, for example. This is because in general the amount of information about the environment of the motor vehicle that is available at the infrastructure is more than could be ascertained by the motor vehicle itself. One reason for this is, in particular, that numerous environment sensors for sensing the environment of the motor vehicle may be arranged within an infrastructure, such that the infrastructure may also sense regions in the environment of the motor vehicle which cannot be sensed by environment sensors of the motor vehicle since the latter for example comprise a limited range or for example comprise a limited sensing angle or for example cannot sense around corners or cannot sense through a wall.

Nevertheless, there may be situations in which it is advantageous for the motor vehicle to drive in an at least partially automated manner only on the basis of the motor vehicle's own environment data and not additionally or exclusively on the basis of the environment data generated by the infrastructure. As a result of the decision process, the motor vehicle may thus advantageously react efficiently to situations specifically present, such that an optimum decision may always be taken by the motor vehicle in a situation-dependent manner.

For example, provision is made for the motor vehicle to drive within a parking area, i.e. to be located within a parking area. For example, the motor vehicle carries out an AVP process or participates in such a process. This would therefore afford the technical advantage that a concept for the efficient at least partially automated guidance of a motor vehicle is provided.

A parking area within the meaning of the description may also be referred to as a parking space and serves as a space for vehicles to park. In particular, the parking area thus forms a contiguous area which comprises a plurality of parking places (in the case of a parking area on private land) or parking zones (in the case of a parking area on public land). The parking area may be comprised by a parking garage according to one embodiment. In particular, the parking area is comprised by a garage.

The abbreviation “AVP” stands for “Automated Valet Parking”. An AVP process comprises, for example, at least highly automated guidance of the motor vehicle from a drop zone, also called a drop-off position, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. An AVP process thus starts in particular at the drop zone. An AVP process thus ends in particular at the pick-up zone. The pick-up zone may be the same as or different from the drop zone.

An AVP motor vehicle is therefore a motor vehicle that may participate in an AVP process. Where motor vehicle is mentioned above and below, it should always be inferred that, for example, but not mandatorily, this is an AVP motor vehicle, even if the term “AVP” is not explicitly used.

An AVP process may be an AVP process according to one of the following AVP types: AVP type 1, AVP type 2, and AVP type 3. However, the AVP types may also change within an AVP process. This means, for example, that one part of an AVP process is carried out according to AVP type 1 and another part of the AVP process is carried out according to an AVP type 2 or AVP type 3. This means, for example, that an AVP process may be divided into partial AVP processes which are each carried out according to one of the AVP types 1, 2 and 3.

AVP type 1 denotes a motor-vehicle-centric AVP process. The primary responsibility for the AVP process lies with the motor vehicle, i.e. with a motor vehicle AVP system.

AVP type 2 denotes an infrastructure-centric AVP process. The primary responsibility for the AVP process lies with the infrastructure, i.e. with an infrastructure AVP system.

AVP type 3 denotes an AVP process shared between the motor vehicle and the infrastructure. Here, a primary responsibility for the AVP process is shared between the motor vehicle, i.e. the motor vehicle AVP system, and the infrastructure AVP system.

An AVP process comprises the following operations or functions:
1. Determining a target position within the parking area for the motor vehicle.
2. Planning a route from a starting position that is comprised by the parking area to the target position.
3. Detecting an object and/or an event and reacting accordingly to a detected object and/or a detected event.
4. Locating the motor vehicle within the parking area.
5. Calculating a target trajectory for the motor vehicle based on the planned route.
6. Controlling lateral and longitudinal guidance of the motor vehicle based on the calculated target trajectory.

The following table indicates an assignment as to which of these operations or functions are carried out by the motor vehicle, i.e. the motor vehicle AVP system, or the infrastructure AVP system, depending on the AVP type, where “I” stands for “infrastructure”, i.e. the infrastructure AVP system, and “K” stands for “motor vehicle”, with the result that “I” indicates that the process is carried out by the AVP system and “K” indicates that the process is carried out by the motor vehicle:

TABLE 1
Functions by AVP type

| | AVP | AVP | AVP |
|---|---|---|---|
| Functions | type 1 | type 2 | type 3 |
| Determining a target position | I & K | I | I |
| within the parking area for the | | | |
| motor vehicle. | | | |
| Planning a route from a starting | K | I | I |
| position that is included in the | | | |
| parking area to the target | | | |
| position. | | | |
| Detecting an object and/or an | K (& | I | I & K |
| event and reacting accordingly | optionally I) | | |
| to a detected object and/or a | | | |
| detected event. | | | |
| Locating the motor vehicle | K | I | K |
| within the parking area. | | | |
| Calculating a target trajectory | K | I | K |
| for the motor vehicle based on | | | |
| the planned route. | | | |
| Controlling lateral and | K | K | K |
| longitudinal guidance of the | | | |
| motor vehicle based on the | | | |
| calculated target trajectory. | | | |

The table above therefore indicates for each function, specifically for each AVP type, whether the function is performed by the infrastructure, i.e. by the infrastructure AVP system, or by the motor vehicle, i.e. by the motor vehicle AVP system. In some cases, provision may be made for the function to be performed by both the infrastructure AVP system and the motor vehicle.

With regard to object and event detection for AVP type 1, provision may optionally be made for the infrastructure AVP system of the infrastructure to also perform this function in addition to the motor vehicle.

AVP types 1, 2 and 3 described here are described in further detail in ISO 23374-2.

The wording “at least partially automated guidance” comprises one or more of the following cases: assisted guidance, partially automated guidance, highly automated guidance, fully automated guidance, autonomous guidance. The wording “at least partially automated” thus comprises one or more of the following wordings: assisted, partially automated, highly automated, fully automated, autonomous.

For example, the motor vehicle is an at least partially automated motor vehicle. Such a motor vehicle is configured for at least partially automated guidance. Partially automated guidance corresponds to an automation level 2 as defined by the German Federal Highway Research Institute (BASt).

For example, the motor vehicle is an at least highly automated motor vehicle. Such a motor vehicle is configured for at least highly automated guidance. Highly automated guidance corresponds to an automation level 3 as defined by the German Federal Highway Research Institute (BASt).

The fact that the motor vehicle is configured at least for highly automated guidance, for example, comprises the case where the motor vehicle is configured for highly automated guidance as well as for fully automated guidance and for autonomous driving. Fully automated guidance corresponds to an automation level 4 as defined by the BASt.

Assisted guidance means that a driver of the motor vehicle continuously performs either the lateral guidance or the longitudinal guidance of the motor vehicle. The respective other driving task (i.e. control of the longitudinal guidance or lateral guidance of the motor vehicle) is carried out automatically. That is to say, in other words, that in the case of assisted guidance of the motor vehicle, either the lateral guidance or the longitudinal guidance is controlled automatically.

Partially automated guidance means that, in a specific situation (for example: driving on an interstate highway, driving within a parking area, overtaking an object, driving within a lane defined by lane markings) and/or for a certain period of time, longitudinal guidance and lateral guidance of the motor vehicle are controlled automatically. A driver of the motor vehicle does not have to manually control the longitudinal and lateral guidance of the motor vehicle. However, the driver must continuously monitor the automatic control of the longitudinal and lateral guidance in order to be able to intervene manually if necessary. The driver must be ready at any time to fully take over the guidance of the motor vehicle.

Highly automated guidance means that, for a certain period of time in a specific situation (for example: driving on an interstate highway, driving within a parking area, overtaking an object, driving within a lane defined by lane markings), longitudinal and lateral guidance of the motor vehicle are controlled automatically. A driver of the motor vehicle does not themself have to manually control the longitudinal and lateral guidance of the motor vehicle. The driver does not have to continuously monitor the automatic control of the longitudinal and lateral guidance in order to be able to intervene manually if necessary. If necessary, a takeover request to take over the control of the longitudinal and lateral guidance is automatically output to the driver, in particular with a sufficient time reserve. This means that the driver must potentially be able to take over the control of the longitudinal and lateral guidance. Limits of the automatic control of the lateral and longitudinal guidance are automatically recognized. With highly automated guidance, it is not possible to automatically bring about a risk-minimized state in every initial situation.

Fully automated guidance means that, in a specific situation (for example: driving on an interstate highway, driving within a parking area, overtaking an object, driving within a lane defined by lane markings), longitudinal and lateral guidance of the motor vehicle are controlled automatically. A driver of the motor vehicle does not have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is stopped, the driver is automatically prompted to take over the driving task (control of the lateral and longitudinal guidance of the motor vehicle), in particular with a sufficient time reserve. If the driver does not take over the driving task, there is an automatic return to a risk-minimized state. Limits of the automatic control of the lateral and longitudinal guidance are automatically recognized. In all situations, it is possible to automatically return to a risk-minimized system state.

Autonomous guidance or driving means that longitudinal and lateral guidance of the motor vehicle are controlled automatically in all situations and not just in one or more specific situations. The driver is no longer necessary as a fallback level. The motor vehicle may therefore drive in driverless fashion. Autonomous guidance corresponds to an automation level 5 according to SAE (J3016), where SAE stands for “Society of Automotive Engineers”.

The wording “to take over the control of the longitudinal and lateral guidance” may also be replaced by the wording “to take over the longitudinal and lateral guidance”.

One embodiment of the method provides for motor vehicle-ascertained environment data describing the environment of the motor vehicle to be received, wherein the deciding is carried out on the basis of the motor vehicle-ascertained environment data.

For example, this affords the technical advantage that the deciding may be carried out efficiently. Consequently, for example, the decision may take account of whether the motor vehicle-ascertained environment data are sufficient for the at least partially automated driving or whether additionally the infrastructure-generated environment data ought to be used as well or only the infrastructure-generated environment data ought to be used.

One embodiment of the method provides for one or more quality attributes assigned to environment data to be received, wherein the deciding is carried out on the basis of the quality attribute(s).

For example, this affords the technical advantage that the deciding may be carried out efficiently. Consequently, in accordance with this embodiment, a quality of the received environment data plays a part in whether or not these environment data ought to be used. The wording “one or more quality attributes assigned to received environment data” means that one or more quality attributes are assigned to the infrastructure-ascertained environment data and/or that one or more quality attributes are assigned to the motor vehicle-generated environment data.

One embodiment of the method provides for the one or more quality attributes to be in each case an element selected from the following group of quality attributes: age of the environment data, quality of the environment data, indication of which safety integrity level the environment data satisfy, wherein the safety integrity level is one of the following: SIL-A, SIL-B, SIL-C, SIL-D, ASIL-A, ASIL-B, ASIL, C, ASIL-D, quality of an infrastructure-side or motor vehicle-side environment sensor which was used for ascertaining the environment data, functionality of an infrastructure-side or motor vehicle-side environment sensor which was used for ascertaining the environment data, current assessment of how much of the environment may be sensed by the motor vehicle itself using one or more motor vehicle-side environment sensors, wherein in particular this assessment is ascertained for example by the motor vehicle and/or for example by infrastructure, a complexity (as “steady-state value”) of the environment, wherein in particular this complexity is stored for example in a digital road map and/or is provided for example by infrastructure, a current ascertained complexity of the environment, historical data regarding accident occurrences and/or complexity of the environment.

For example, this affords the technical advantage that particularly suitable quality attributes may be used.

The abbreviation “ASIL” stands for “Automotive Safety Integrity Level”. “Automotive Safety Integrity Level” is a key component of the standard ISO 26262. ASIL distinguishes between four different ASIL risk levels, denoted by ASIL-A, ASIL-B, ASIL-C and ASIL-D.

The abbreviation “SIL” stands for “Safety Integrity Level”. “Safety Integrity Level” is a key component of the standard IEC EN 61508. SIL distinguishes between four different SIL risk levels, denoted by SIL-1, SIL-2, SIL-3 and SIL-4.

One embodiment of the method provides for an infrastructure-ascertained use proposal for the infrastructure-generated environment data to be received which proposes how the infrastructure-generated environment data ought to be used by the motor vehicle, wherein the deciding is carried out on the basis of the use proposal.

For example, this affords the technical advantage that the deciding may be carried out efficiently. Since the infrastructure generally comprises or may comprise greater knowledge about the environment, the infrastructure may make a particularly suitable proposal as to which driving strategy may or should be used.

One embodiment of the method provides for an infrastructure-ascertained availability indication to be received which indicates an availability of infrastructure support for at least partially automated guidance of motor vehicles within a defined region in the environment of the motor vehicle, wherein the deciding is carried out on the basis of the availability indication. For example, this affords the technical advantage that the deciding may be carried out efficiently.

The infrastructure, in particular the infrastructure-side environment sensors, may analyze itself/themselves continuously, for example. If the functionality is restricted and/or the quality of the environment data is restricted, the infrastructure may transmit its analysis result to the motor vehicle and thus transmit or give to the motor vehicle an aid in the decision for the driving strategy.

One embodiment of the method provides for the method steps to be carried out while the motor vehicle is located within a defined region for which infrastructure support for at least partially automated guidance of motor vehicles is available. For example, this affords the technical advantage that the method is implemented expediently. If the motor vehicle is located in a region entirely without infrastructure support, then it usually does not require a decision for a driving strategy either. In a region with infrastructure support, for example, the motor vehicle may decide which driving strategy is necessary, for example depending on quality of motor vehicle-side environment data and infrastructure-side environment data.

One embodiment of the method provides for the method steps to be carried out as a loop as long as a predetermined run condition is met or until a predetermined termination condition occurs. For example, this affords the technical advantage that the method may be carried out efficiently. For example, this involves constantly rechecking what is the best driving strategy for the next route section/distance, which is particularly expedient and advantageous since it may be the case, for example, that an infrastructure sensor does not function correctly in a partial region, with the result that a different driving strategy needs to be chosen.

One embodiment of the method provides for the predetermined termination condition to be the motor vehicle leaving the defined region or the motor vehicle reaching a predetermined target position. For example, this affords the technical advantage that a suitable end point may be used for the method. A target position is for example a target position within the defined region or is for example a target position outside the defined region. A target position is for example one of the following positions: parking position, drop zone, pick-up zone.

One embodiment of the method provides for the method to be a computer-implemented method. The device according to the second aspect is configured in terms of programming, for example, to execute the computer program according to the fourth aspect.

Device features are analogously evident from corresponding method features, and vice versa. This means, in particular, that technical functionalities of the method are evident from corresponding technical functionalities of the device, and vice versa.

For example, one or more environment sensors are arranged in a spatially distributed manner within the infrastructure. For example, the motor vehicle comprises one or more environment sensors.

An environment sensor within the meaning of the description is for example one of the following environment sensors: radar sensor, LiDAR sensor, image sensor, in particular image sensor of a video camera, magnetic field sensor, infrared sensor and ultrasonic sensor. An environment sensor of the motor vehicle may be referred to as a motor vehicle environment sensor, for example. An environment sensor of the infrastructure may be referred to as an infrastructure environment sensor, for example.

Infrastructure-generated environment data are thus generated or ascertained within the infrastructure. For example, the environment of the motor vehicle is sensed by the infrastructure by way of one or more infrastructure environment sensors in order to ascertain sensing-based environment data describing the environment of the motor vehicle.

Motor vehicle-generated environment data are generated or ascertained within the motor vehicle.

In one embodiment of the method, the latter comprises motor vehicle-side ascertaining of environment data describing the environment of the motor vehicle.

In one embodiment of the method, the latter comprises motor vehicle-side sensing of the environment of the motor vehicle by way of one or more motor vehicle environment sensors in order to ascertain sensing-based environment data describing the environment of the motor vehicle. This means, in particular, that the motor vehicle-side ascertaining of the environment data is carried out on the basis of the motor vehicle-side sensing of the environment of the motor vehicle by way of one or more motor vehicle environment sensors.

One embodiment of the method provides for the latter to comprise at least partially automated control of the longitudinal and/or lateral guidance of the motor vehicle on the basis of the control signals that are output.

The method is carried out by way of the device, for example.

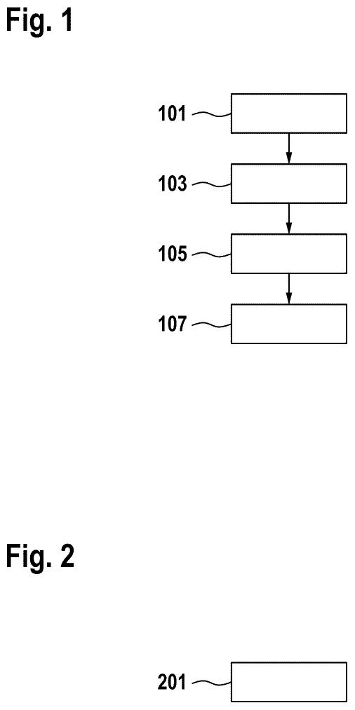

FIG. 1 shows a flowchart of a method for the at least partially automated guidance of a motor vehicle, comprising the following steps:
receiving 101 infrastructure-generated environment data describing an environment of the motor vehicle,
deciding 103 which of three driving strategies ought to be used for the at least partially automated guidance of the motor vehicle, on the basis of the infrastructure-generated environment data,
wherein a first of the three driving strategies stipulates that only motor vehicle-generated environment data, and not the infrastructure-generated environment data, ought to be used for a representation of the environment of the motor vehicle on the basis of which the motor vehicle ought to be guided in an at least partially automated manner,
wherein a second of the three driving strategies stipulates that motor vehicle-generated environment data and the infrastructure-generated environment data ought to be used for a representation of the environment of the motor vehicle on the basis of which the motor vehicle ought to be guided in an at least partially automated manner,
wherein a third of the three driving strategies stipulates that only the infrastructure-generated environment data, and not motor vehicle-generated environment data, ought to be used for a representation of the environment of the motor vehicle on the basis of which the motor vehicle ought to be guided in an at least partially automated manner,
generating 105 control signals for the at least partially automated control of the longitudinal and/or lateral guidance of the motor vehicle on the basis of the decision,
outputting 107 the generated control signals.

FIG. 2 shows a device 201 configured to perform all the steps of the method according to the first aspect. For example, the device 201 comprises an input configured to receive the infrastructure-generated environment data. The input is configured for example to receive motor vehicle-ascertained environment data.

The device 201 comprises for example a processor unit configured to carry out the step of deciding by executing a plurality of program instructions stored on a non-transitory computer-readable medium. The processor unit comprises for example one or more processors. The processor unit is configured for example to carry out the step of generating control signals.

The device 201 comprises, for example, an output configured to output the generated control signals. For example, the input and the output are each implemented as a separate communication interface or are implemented for example as a common communication interface. A communication interface is for example a WLAN communication interface or is for example a mobile radio interface or is for example a CAN bus interface.

For example, the device 201 is implemented by a control unit, in particular main control unit, of a motor vehicle or for a motor vehicle. This means in particular that the method in accordance with the first aspect may be carried out by a control unit, for example by a main control unit, of a motor vehicle or for a motor vehicle. The computer program according to the fourth aspect described herein is executed for example by such a control unit or main control unit.

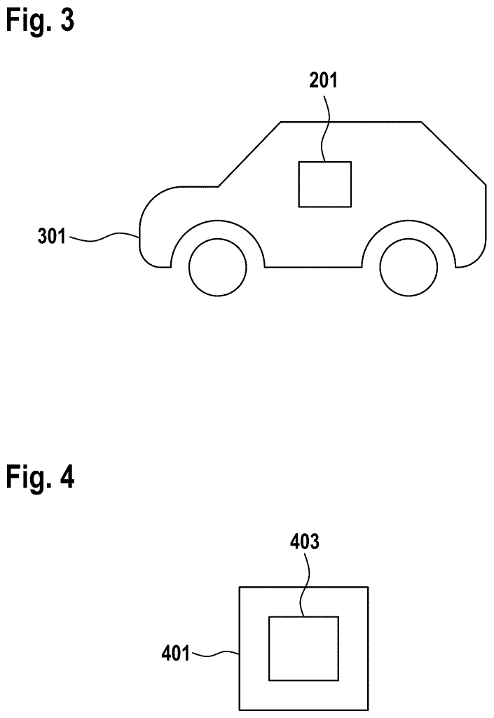

FIG. 3 shows a motor vehicle 301 comprising the device 201 from FIG. 2. The motor vehicle 301 comprises, for example, one or more environment sensors configured to sense an environment of the motor vehicle 301. On the basis of this sensing, by way of example, environment data are ascertained, for example by the device 201. These environment data describe the environment of the motor vehicle and are thus motor vehicle-ascertained environment data within the meaning of the description.

FIG. 4 shows a machine-readable storage medium 401 on which a computer program 403 is stored. The computer program 403 comprises instructions which, when the computer program 403 is executed by a computer, such as the control unit described above, cause the latter to perform a method in accordance with the first aspect. The machine-readable storage medium 401 is a non-transitory computer-readable storage medium.

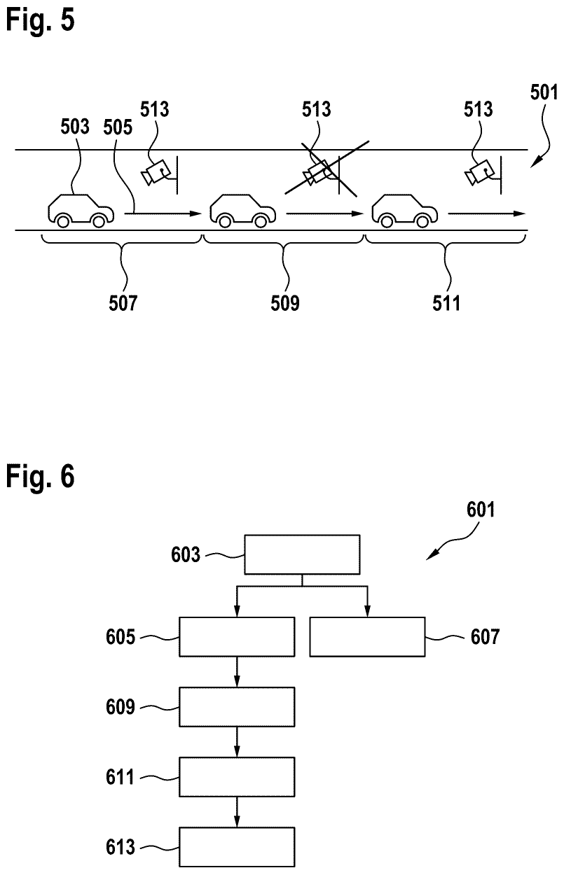

FIG. 5 shows a parking area 501 as one example of an infrastructure within the meaning of the description. Within the parking area 501, an at least partially automated motor vehicle 503 drives in travel direction 505 at three different points in time, which is represented by three depicted motor vehicles.

Within the parking area 501, three regions are defined: a first region 507, a second region 509 and a third region 511. Within the first region 507 and within the third region 511, a plurality of environment sensors are arranged in a spatially distributed manner. This is represented symbolically in each case by a camera bearing the reference sign 513. This means that, for these two regions 507, 511, the infrastructure may sense the environment of the motor vehicle 503 and may ascertain sensing-based environment data.

The motor vehicle 503 is an AVP motor vehicle, for example, and may carry out an AVP process or participate in such a process within the parking area 501, for example.

Within the second region 509, no environment sensors which may be used explicitly for carrying out the AVP process or which satisfy the requirements for such an AVP process are arranged within the infrastructure, i.e. within the parking area 501. By way of example, there are environment sensors arranged within the second region 509. However, these sensors do not fulfill specific safety integrity levels, and so their sensor data cannot be used for the AVP process for safety reasons. This is represented symbolically by a video camera 513 that is scored through or crossed out.

Within the second region 509 of the embodiment shown in FIG. 5, there is no infrastructure support for at least partially automated driving of the motor vehicle 503. This need not necessarily be disadvantageous since, for example, driving through the second region 509 is not technically complex, such that the motor vehicle 503 may drive in an at least partially automated manner without infrastructure support within the second region 509.

Traversing the first region 507 and the second region 511 may be a technically complex matter for an at least partially automated motor vehicle, for example, such that infrastructure monitoring by corresponding environment sensors is provided for these regions. The infrastructure transmits the infrastructure-ascertained environment data to the motor vehicle 503, such that the latter, in accordance with the concept described here, may decide whether or not to use these environment data.

FIG. 6 shows a first block diagram 601 that elucidates the concept described here by way of example. The following block diagrams describe an exemplary AVP process for an at least highly automated motor vehicle which is intended to carry out an AVP process, or to participate in such a process, within a parking area.

In accordance with the first block diagram 601 shown in FIG. 6, a function block 603 is provided, in accordance with which a pre-initialization is carried out. This pre-initialization may, for example, be carried out even before the motor vehicle is located at the drop zone.

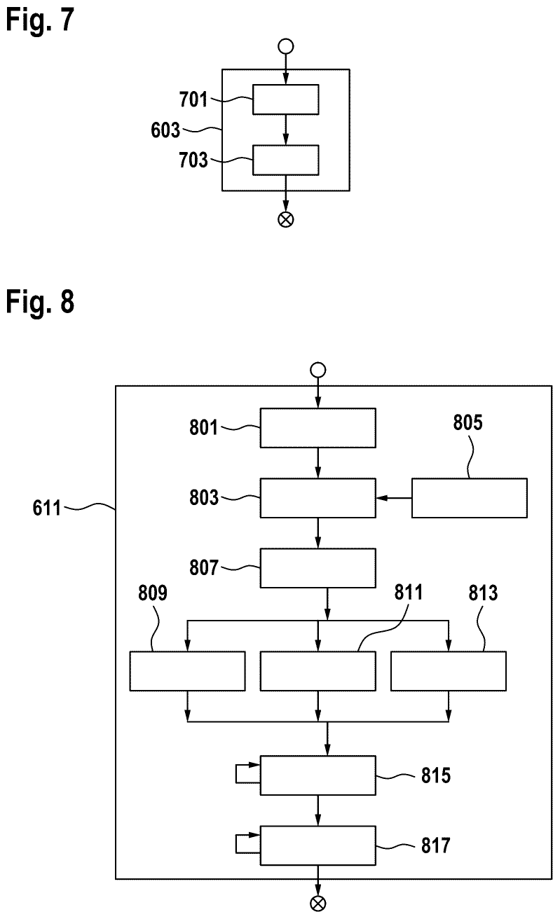

The pre-initialization in accordance with the function block 603 is described in further detail in FIG. 7. Generally, the pre-initialization involves checking whether specific prerequisites for carrying out the AVP process are satisfied. If they are not satisfied, then the AVP process terminates in accordance with the function block 607. For example, in the context of the pre-initialization, it is established that an AVP process cannot be carried out with the specific motor vehicle within the parking area. By way of example, the motor vehicle does not satisfy specific technical prerequisites.

If the conditions or prerequisites are satisfied, the method is continued in the function block 605. In accordance with the function block 605, the AVP infrastructure is sent an AVP request to carry out an AVP process with the motor vehicle.

According to a following function block 609, an initialization 609 is carried out. The initialization 609 is described further in FIG. 10. According to a following function block 611, at least highly automated driving of the motor vehicle takes place after successful initialization. This is based on one of the three driving strategies described in the context of the description.

When a target position is reached or when a termination condition is present, the method ends in accordance with the function block 613.

FIG. 7 shows the pre-initialization in accordance with the function block 603 in greater detail. Accordingly, a check of preconditions is carried out in accordance with a function block 701. In this case, for example, a motor vehicle backend checks AVP preconditions with the AVP motor vehicle and with an AVP backend. Specifically, for example, a motor vehicle backend checks or verifies AVP preconditions with a motor vehicle AVP system of the motor vehicle, which is intended to carry out the AVP process, and an AVP backend. A motor vehicle backend is a backend of the manufacturer of the motor vehicle. An AVP backend is a backend of the operator of an infrastructure AVP system.

AVP preconditions comprise, for example, one or more of the following conditions: The motor vehicle must be approved for AVP and in particular for AVP type 1 and AVP type 2. The motor vehicle must be ready for the AVP process. Being ready means, in particular, that all the components of the motor vehicle required for the AVP process must be ready. Being ready means, in particular, that there is no fault or that no fault has occurred. The infrastructure AVP system must be ready for the AVP process. Being ready means, in particular, that all the components of the infrastructure AVP system required for the AVP process must be ready. Being ready means, in particular, that there is no fault or that no fault has occurred.

According to a function block 703, the pre-initialization 603 comprises for example an exchange of one or more motor vehicle certificates. Specifically, for example, a motor vehicle certificate or motor vehicle certificates is or are exchanged between the motor vehicle AVP system or motor vehicle backend and the AVP backend. The AVP backend may gain access to one or more motor vehicle components using these certificates, for example.

Furthermore, for example, further data are exchanged between motor vehicle and AVP backend. By way of example, the AVP backend transmits a digital map of the parking area to the motor vehicle, such that the latter may drive through the parking area in an at least highly automated manner on the basis of said digital map.

The pre-initialization thus involves in particular only checking whether the AVP process might presumably work. In other words, in particular, no functionality such as waking up the motor vehicle is carried out since the motor vehicle may for example still be en route to the parking area. What is carried out in particular in the context of the pre-initialization 603 is checking whether the motor vehicle and the infrastructure satisfy the conditions mentioned above and/or below. What is carried out in particular in the context of the pre-initialization is transferring data required for the AVP process, such as certificates, for example.

FIG. 8 shows the function block 611 in greater detail.

A function block 801 provides for the AVP infrastructure, i.e. the AVP system of the infrastructure, to define a target position for the motor vehicle and to ascertain a target path to the target position from a drop zone, for example, and to propose same to the motor vehicle. This means that the infrastructure transmits the target position and a proposal for a target path to the target position to the motor vehicle.

Furthermore, environment data describing the environment of the motor vehicle are ascertained by the infrastructure. The infrastructure transmits these infrastructure-ascertained environment data to the motor vehicle. The motor vehicle thus receives these environment data. By way of example, the infrastructure transmits these environment data continuously. Environment data within the meaning of the description comprise for example an object list and/or other information, for example an occupancy map and/or information about a traffic state within the parking area and/or signal images from light signaling systems of the parking area. Environment data within the meaning of the description comprise information about open spaces, for example.

Receiving the environment data on the part of the motor vehicle is carried out in accordance with the function block 803. The transmission of the environment data to the motor vehicle by the infrastructure is represented symbolically by the element bearing the reference sign 805.

In accordance with a function block 807, the motor vehicle takes a decision concerning which of the three driving strategies described in the context of the description ought to be taken as a basis for the motor vehicle to be guided in an at least highly automated manner. This decision is based on the received environment data which were ascertained by the infrastructure. The decision is additionally based for example on motor vehicle-ascertained environment data describing the environment of the motor vehicle. The decision is based for example on one or more of the quality attributes mentioned in the description. The decision is based for example on an infrastructure-side proposal as to which driving strategy ought to be used.

Accordingly, the motor vehicle may decide on the first driving strategy 809, for example. For example, the motor vehicle may decide on the second driving strategy 811. For example, the motor vehicle may decide on the third driving strategy 813. According to the driving strategy chosen, corresponding control signals for the at least highly automated control of the lateral and longitudinal guidance of the motor vehicle are generated and output.

In the context of at least highly automated driving, a function block 815 provides for the motor vehicle to be continuously located. A function block 817 provides for the motor vehicle to drive in an at least highly automated manner and to follow the proposed target path, for example. For example, the control signals are generated on the basis of the proposal for a target path. In the context of at least highly automated driving, provision is made for the motor vehicle to sense its environment using its own environment sensors and, upon an obstacle being detected, to plan for example a trajectory or journey that leads around the detected obstacle, such that the motor vehicle drives around the detected obstacle in an at least highly automated manner according to this ascertained trajectory or according to the ascertained path. It is noted that the motor vehicle does not have to follow the proposal for a target path. By way of example, the motor vehicle may plan its own path to the target position.

By way of example, a time synchronization, i.e. as it were a comparison of clock times, is carried out between the motor vehicle AVP system and an infrastructure AVP system. This may be carried out for example before the motor vehicle departs from the drop zone and/or may also be carried out during the at least highly automated driving of the motor vehicle within the parking area.

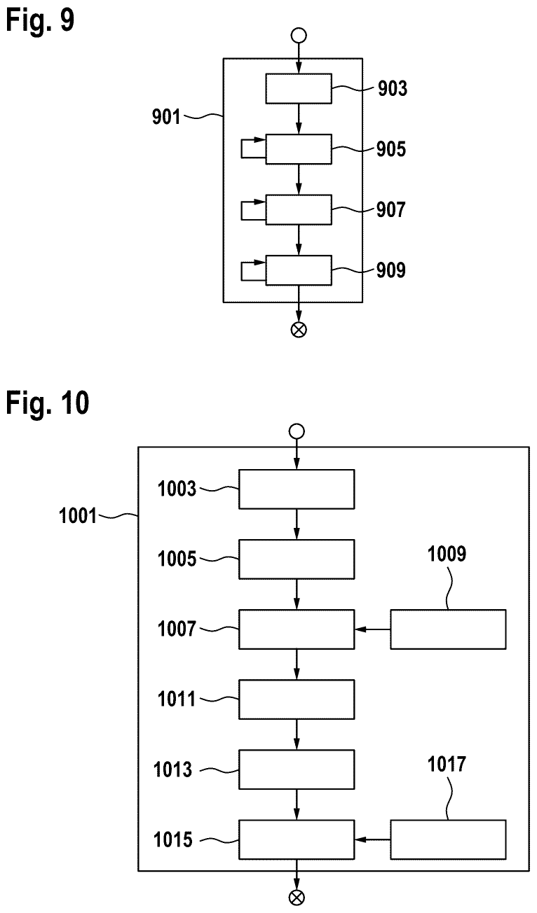

FIG. 9 shows a function block 901, in accordance with which the motor vehicle drives in an at least highly automated manner within the parking area in accordance with the first driving strategy. The function block 901 or parts of the function block 901 may be used for example in the context of the method described here.

A target position and a target path from a current position of the motor vehicle, for example from the drop zone, to the target position are ascertained by the infrastructure. These items of information, i.e. the target position and the ascertained target path, are transmitted to the motor vehicle. This ascertaining and the transmitting are carried out by the infrastructure in accordance with a function block 903. On the basis of these items of information, the motor vehicle may drive in an at least highly automated manner.

During the at least highly automated travel of the motor vehicle within the parking area, the function block 905 is carried out by the motor vehicle. In accordance with the function block 905, the motor vehicle senses its environment using its environment sensors in order to detect obstacles in the environment. If an obstacle is detected, the motor vehicle for example independently plans an evasion trajectory around the obstacle and drives along said trajectory in an at least highly automated manner, for example.

Furthermore, a function block 907 provides for the motor vehicle to locate, for example continuously locate, itself within the parking area. The locating means, for example, that the motor vehicle locates itself within the digital map of the parking area. A function block 909 corresponding to the function block 817 in accordance with FIG. 8 is provided.

FIG. 10 shows an initialization process 1001 such as may be used in the context of the concept or method described here.

A function block 1003 provides for the motor vehicle to connect to the AVP infrastructure. For example, a wireless communication connection between motor vehicle and infrastructure is thus set up. This means, in particular, that the motor vehicle AVP system connects to the infrastructure AVP system wirelessly. Data or items of information may thus be exchanged via this wireless communication connection between motor vehicle AVP system and infrastructure AVP system.

A following function block 1005 provides a handshake between motor vehicle and infrastructure. The motor vehicle informs the AVP infrastructure for example that it would like to park within the parking area in accordance with AVP.

A following function block 1007 provides for items of information to be exchanged between AVP motor vehicle and AVP infrastructure. Such items of information comprise for example a target position and a proposal for a target path to the target position. It is noted at this juncture that during the at least highly automated driving of the motor vehicle within the parking area, the infrastructure may ascertain a new target position and a new proposal for a new target path to the new target position and may transmit same to the motor vehicle. This means that the target position and a corresponding target path to the target position may be dynamically adapted by the infrastructure while the motor vehicle is driving in an at least highly automated manner within the parking area.

A function block 1011 provides for the motor vehicle to locate itself.

A function block 1013 provides a time synchronization between AVP infrastructure and AVP motor vehicle. A comparison of clock times between AVP infrastructure and AVP motor vehicle is thus carried out, such that an identical time base is available to them.

A function block 1015 provides for the motor vehicle to be switched into an operating mode in accordance with which it drives in an at least highly automated manner and in accordance with one of the three driving strategies.

The reference sign 1009 denotes the fact that the infrastructure may dynamically adapt the target position and the target path to the target position.

The reference sign 1017 symbolically denotes data that the infrastructure may transmit to the motor vehicle. Such data comprise for example the environment data described here, object lists, quality attributes, free space map, information from and/or about one or more electronic signal units. A signal unit is for example: light signaling system, electronic traffic sign. Information about an electronic signal unit comprises a position, for example. Information from an electronic signal unit comprises a signal image and/or information provided by the electronic signal unit, for example.

The block diagrams in accordance with FIGS. 11 to 13 show in each case by way of example the operations such as may be carried out within the motor vehicle or within the infrastructure, for example, in the context of the concept described here.

FIG. 11 shows the procedure from the standpoint of the motor vehicle.

In accordance with the function block 1101, the motor vehicle is approaching a defined region within the parking area. In this case, the motor vehicle is driving on the basis of the first driving strategy, for example. The defined region is identified by the reference sign 1103. For this region there is support by the infrastructure for the at least highly automated driving.

While the motor vehicle is located within the defined region 1103, a function block 1105 is implemented. The function block 1105 identifies an at least highly automated driving mode. This means that the motor vehicle is driving in an at least highly automated manner. The function block 1105 is carried out continuously until the motor vehicle leaves the defined region 1103 or until it has arrived at its target position. After leaving the defined region 1103, the motor vehicle is again driving without infrastructure support, in particular. The motor vehicle receives infrastructure-generated environment data and, in accordance with the concept described here, decides whether or not to use these data.

The arrow bearing the reference sign 1111 identifies or represents the fact that the function block 1105 is carried out continuously.

The reference sign 1109 identifies the fact that the motor vehicle is driving without infrastructure support or has arrived at its target position. If, in the context of the at least highly automated driving, locating of the motor vehicle goes wrong or if one or more conditions for a field of application of the motor vehicle are no longer met, then a function block 1107 is implemented. The field of application of the motor vehicle is defined by the ODD, where ODD stands for “Operational Design Domain”.

In accordance with the function block 1107, at least one so-called “minimal risk maneuver” (MRM) is performed. MRMs as part of highly automated systems aim to minimize the risk during a transition phase from automated to manual driving. One such MRM comprises an emergency stop, for example. One such MRM comprises operating the motor vehicle in an emergency mode, also called “limp-home”, for example. Even if information that the motor vehicle obtains from the infrastructure is erroneous or incomplete, the function block 1107 is nevertheless carried out.

Furthermore, arrows 1113, 1115 and 1117 are depicted in FIG. 11. The arrow 1113 denotes the transition from the function block 1105 to the function block 1109. The two arrows 1115 and 1117 each denote a transition from the function block 1105 to the function block 1107. Furthermore, arrows 1119 and 1121 are depicted. The arrow 1119 denotes the transition from the function block 1107 to the function block 1109. The arrow 1121 denotes the transition from the function block 1107 to the function block 1105.

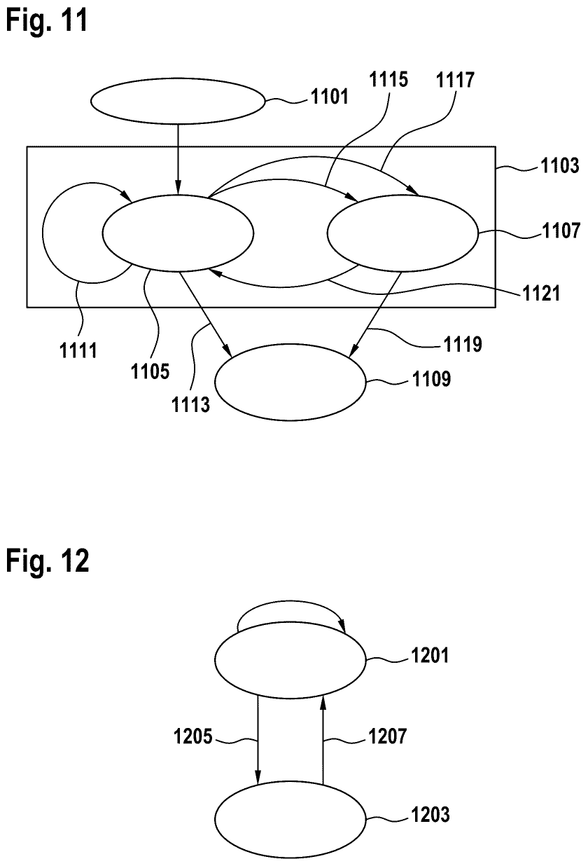

FIG. 12 shows the operations described here from the standpoint of the infrastructure.

In accordance with a normal mode 1201, environment sensing by the infrastructure takes place using one or more infrastructure environment sensors. Environment data are ascertained by the infrastructure on the basis of the sensing. These environment data are transmitted to the motor vehicle by the infrastructure. For example, the infrastructure ascertains quality attributes for the environment data and likewise transmits these ascertained quality attributes to the motor vehicle.

For the case where in the infrastructure an error (for example: blocking of an infrastructure-side environment sensor by a truck and/or a decalibration of an infrastructure-side environment sensor) occurs or a data quality cannot be guaranteed (for example on account of fog, darkness or the like), there is a transition from the normal mode 1201 to a function block 1203.

In accordance with the function block 1203, the infrastructure is in an error mode known to it and notifies the motor vehicle of this and/or no longer distributes information. Not distributing information may be defined as an error flag or as an error indicator.

In the error mode 1203, therefore, the motor vehicle is notified of the non-usability of the infrastructure as “system state”. That occurs in particular not just once, but in particular as long as the error exists.

For the case where the error is eliminated (for example: truck drives away, etc.) or the cause of the error is no longer present (fog disperses, sun rises, etc.), there is a transition or changeover from the error mode 1203 to the normal mode 1201 again.

Since transitions take place in both directions, two arrows 1205 and 1207 symbolizing these transitions are depicted.

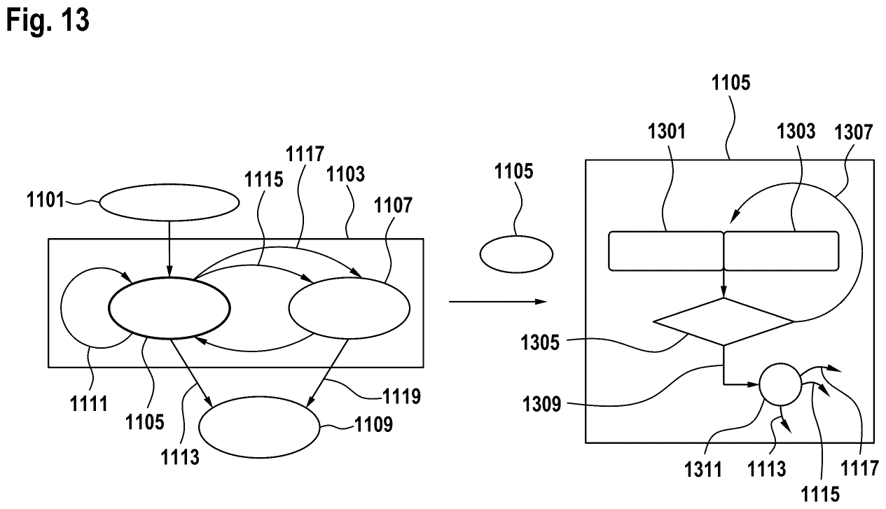

FIG. 13 shows the block diagram in accordance with FIG. 11 in a more detailed view. Specifically, the function block 1105, i.e. the at least highly automated driving, is elucidated further.

While the motor vehicle is driving in an at least highly automated manner within the defined region 1103, it receives motor vehicle-ascertained environment data in accordance with a function block 1301. Furthermore, in accordance with a function block 1303, infrastructure-ascertained environment data are received. By way of example, the received environment data are assigned quality attributes, which are therefore likewise received.

On the basis of these items of information, i.e. on the basis of the environment data and in particular on the basis of the quality attributes, in accordance with a function block 1305, a decision is taken as to which of the three driving strategies ought to be used for the at least highly automated driving of the motor vehicle. Accordingly, in accordance with the decision, the motor vehicle is driven in an at least partly automated manner, such that, in accordance with the arrow 1307, there is a return again to the function blocks 1301 and 1303, in accordance with which current environment data and quality attributes are once again received, such that for every new received environment data the motor vehicle decides whether or not the infrastructure-ascertained environment data ought to be used according to the second or third driving strategy.

If the function block 1305 ascertains that the environment data, i.e. both the infrastructure-ascertained environment data and the motor vehicle-ascertained environment data, do not suffice to enable at least highly automated driving in one of the three driving strategies, then in accordance with the arrow 1309 there is a transition to a function block 1311, in accordance with which there are multiple possibilities for continuing the method, identified symbolically in each case by the three arrows 1113, 1115 and 1117 (see also FIG. 11 and corresponding explanations).

The decision as to which of the three driving strategies ought to be used for the at least highly automated driving of the motor vehicle holds true for example only for a predetermined period of time or for a situation specifically present or for a predetermined distance, for example for the next x meters, where x is a positive real number greater than zero. A situation specifically present comprises a ramp situation, for example. A ramp situation denotes a situation in which the motor vehicle is intended to traverse a ramp, i.e. is intended to drive up or drive down said ramp.

What is claimed is:

1. A method for guiding a motor vehicle, comprising:
receiving an infrastructure-generated environment data describing an environment of the motor vehicle;
deciding which of three driving strategies to use for an at least partially automated guidance of the motor vehicle based on the infrastructure-generated environment data,
a first of the three driving strategies stipulates that only a motor vehicle-generated environment data, and not the infrastructure-generated environment data, is used for a representation of the environment of the motor vehicle, on the basis of which the motor vehicle is to be guided in an at least partially automated manner,
a second of the three driving strategies stipulates that the motor vehicle-generated environment data and the infrastructure-generated environment data are used for the representation of the environment of the motor vehicle, on the basis of which the motor vehicle is to be guided in the at least partially automated manner, and
a third of the three driving strategies stipulates that only the infrastructure-generated environment data, and not the motor vehicle-generated environment data, is used for the representation of the environment of the motor vehicle, on the basis of which the motor vehicle is to be guided in the at least partially automated manner;
generating a plurality of control signals for an at least partially automated control of a longitudinal guidance and/or a lateral guidance of the motor vehicle based on the driving strategy decided upon in the deciding step; and
outputting the control signals.

2. The method of claim 1, wherein, in the deciding step, the decision of which of the three driving strategies to use is further based on the motor vehicle-generated environment data.

3. The method of claim 2, wherein the infrastructure-generated environment data and/or the motor vehicle-generated environment data is assigned a quality attribute, the decision of which of the three driving strategies to use is further based on the quality attribute.

4. The method of claim 3, wherein the quality attribute is selected from the group including: an age of an environment data, a quality of the environment data, an indication of which safety integrity level the environment data satisfy, a quality of an infrastructure-side or a motor vehicle-side environment sensor used to obtain the environment data, a functionality of the infrastructure-side or the motor vehicle-side environment sensor used for ascertaining the environment data, a current assessment of how much of the environment may be sensed by the motor vehicle using one or more motor vehicle-side environment sensors, and a complexity of the environment.

5. The method of claim 4, wherein the complexity is stored for example in a digital road map and/or is provided for example by an infrastructure.

6. The method of claim 5, wherein the complexity is based on historical data.

7. The method of claim 1, wherein an infrastructure-ascertained use proposal for the infrastructure-generated environment data proposes the use of the infrastructure-generated environment data by the motor vehicle, the decision of which of the three driving strategies to use is further based on the infrastructure-ascertained use proposal.

8. The method of claim 1, wherein an infrastructure-ascertained availability indication indicates an availability of infrastructure support for the at least partially automated guidance of the motor vehicles within a defined region in the environment of the motor vehicle.

9. The method of claim 8, wherein the decision of which of the three driving strategies to use is further based on the infrastructure-ascertained availability indication.

10. The method of claim 1, wherein the receiving, deciding, generating, and outputting steps are carried out while the motor vehicle is within a defined region having an infrastructure support for the at least partially automated guidance of the motor vehicle.

11. The method of claim 1, wherein the receiving, deciding, generating, and outputting steps are carried out as a loop as long as a predetermined run condition is met or until a predetermined termination condition occurs.

12. The method of claim 11, wherein the predetermined termination condition is the motor vehicle leaving a defined region or the motor vehicle reaching a predetermined target position.

13. A device, which performs the method of claim 1.

14. A motor vehicle comprising the device of claim 13.

15. A computer program comprising a plurality of instructions which, when executed by a computer, cause the computer to carry out the method of claim 1.

16. A non-transitory machine-readable storage medium on which the computer program claimed in claim 15 is stored.
